(19) United States
(12) Patent Application Publication
(10) Pub. No.: US 2017/0004449 A1
(43) Pub. Date: Jan. 5, 2017

(54) SYSTEMS, TOOLS, AND METHODS FOR EFFECTIVE LIMITED ADMINISTRATIVE PROJECT MANAGEMENT

(71) Applicants: Malcolm Hubbard, De Kalb Junction, NY (US); Stephen W. Raab, Santa Fe, NM (US); Rajkumar Sunchukeshava, Nashua, NH (US)

(72) Inventors: Malcolm Hubbard, De Kalb Junction, NY (US); Stephen W. Raab, Santa Fe, NM (US); Rajkumar Sunchukeshava, Nashua, NH (US)

(21) Appl. No.: 15/201,449

(22) Filed: Jul. 2, 2016

Related U.S. Application Data
(60) Provisional application No. 62/188,469, filed on Jul. 2, 2015.

(51) Int. Cl. G06Q 10/10; G06Q 10/06

(52) U.S. Cl. CPC G06Q 10/103; G06Q 10/063114; G06F 3/0481

(57) ABSTRACT

The present invention relates to project management tools, systems, and related methods, suitable for effective limited administrative management (ELAM) of one or more projects. In particular, the present invention provides a project management tool for use in power plant critical operations and maintenance, e.g., outage activities.

### RELATED APPLICATIONS

This application claims priority to U.S. Provisional Patent Application No. 62/188,469, filed on Jul. 2, 2015, under Attorney Docket No. EP3-001-1; the entirety of which is incorporated herein by reference.

### BACKGROUND OF THE INVENTION

Generally, commercial projects may be classified into four phases including (1) pre-commercial, (2) maintenance & engineering, (3) asset management, and (4) operations. Solutions to streamlining management of each of these phases often involve complicated and redundant processes that utilize multiple administrators for tracking multiple tasks, assessments, documents, and people. Alternatively, solutions for those with significant resources involve large teams of administrators, expensive software programs that require significant expertise to operate, or both. Further, in many areas requiring project management, like power plant operations and maintenance (such as outage management), the generalized scope and generalized strategies of existing project management tools are not suitable for configuring to the needs of these specific projects.

Such project management solutions, for example used in power plant operations and maintenance such as outage management, are often assembled with non-secure, duplicative components for work and task management through a work order management system, monitoring/tracking status updates via basic spreadsheets, and other software to display and report outage schedules; and notably, these work order management cannot be synchronized to the spreadsheets. Moreover, the lists of critical activities in these spreadsheets, located locally on each user's hard drive, are necessarily modified by multiple people, further making revision control difficult to manage.

Although spreadsheets are quick to assemble, they are dependent on the person building the list of critical activities for quality and accuracy. Such systems provide a noteworthy lack of efficiency in managing tasks and required meetings. In fact, the process of updating tasks in the spreadsheet for specific power plant operations and maintenance activities inefficiently requires technicians and engineers to report directly to the outage managers. Analytics and assembly of tasks, assessments, and risks are not designed into these methods, which therefore makes it difficult to assemble lessons learned.

In contrast, the alternative more resource driven solution of project management would involve using a complex and elaborate project software system. Known systems may be used to manage the project tasks and synchronize work with scheduling. However, in order to obtain useful outputs from the system, such systems require dedicated teams of administrators with significant system expertise established through the completion of difficult courses. The high level of skill required to effectively utilize the system generally renders it unusable and confusing to the unskilled administrative users. In fact, since these project management software systems are not designed or configured for a particular project such as power outage management, analytical reports related to the specific project remain difficult to extract.

Accordingly, there is significant need for novel project management tools suitable for effective management by a single project administrator, or limited administrative team, without the need for significant expertise in the use of the tool.

### SUMMARY OF THE INVENTION

Accordingly, the present invention is directed to project management tools, systems, and related methods, suitable for effective limited administrative management (ELAM) of one or more projects. The methods and tools presented herein are suitable for effective management by a single project administrator, or limited administrative team, without the need for significant expertise in the use of the tool. In particular, the present invention provides a project management tool for use in power plant operations and maintenance such as outage management.

The tools, systems and methods provided herein address the significant business challenge of effective project management without large teams of administrators, which has remained unaddressed until the present invention. In particular, the present methods and the implementation of these methods via computer technology and the internet has previously not been attained. Moreover, the present invention increases the likelihood of on-time and on budget project management, like power plant outage management and other critical operations and maintenance activities; supports a continuous improvement strategy; affords efficient use of time related to communications and task management; communication improvement, e.g., automated alerts; and ultimately results in significant cost savings related to projects, e.g., outages, as a result of early detection and risk mitigations. In this way, the present invention provides a solution to this challenging problem using novel and inventive methods that are rooted in computer technology.

As such, one aspect of the invention provides a project management tool suitable for effective limited administrative management (ELAM) of a project comprising a machine-readable medium having instructions stored thereon for execution by a processor to perform a method. The method comprises the steps of: providing a dynamic graphical user interface (GUI) between stored data and a primary user, wherein said dynamic GUI may be modified by the primary user; presenting to said primary user a project based advanced activity array in said dynamic GUI, wherein an array derivative data set is created upon selection of a project and comprises a framework for the data associated with one or more project assessments derived from the advanced activity array; assigning tasks to one or more tertiary users; distributing said tasks to said tertiary users and requesting response input into the array derivative data set; monitoring the status of the response input into the array derivative data set from said tertiary users using active loop technology; and storing the response input for each task. In this way, a primary user may monitor the status of each task in each assessment of the project in the dynamic GUI. In certain aspects, the project is management of power plant operations and maintenance, such as outage management. In certain aspects, the project is outage management of a power plant, e.g., the management of a single turbine.

In another aspect, the invention provides a method of project management suitable for effective limited administrative management (ELAM) of a project. The method comprises the steps of: providing a dynamic graphical user interface (GUI) between stored data and a primary user, wherein said dynamic GUI may be modified by the primary user; presenting to said primary user a project based advanced activity array in said dynamic GUI, wherein an array derivative data set is created upon selection of a project and comprises a framework for the data associated with one or more project assessments derived from the advanced activity array; assigning tasks to one or more tertiary users; distributing said tasks to said tertiary users and requesting response input into the array derivative data set; monitoring the status of the response input into the array derivative data set from said tertiary users using active loop technology; and storing the response input for each task. In this way, a primary user may monitor the status of each task in each assessment of the project in the dynamic GUI. In certain aspects, the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant. In certain aspects, the project is management of power plant operations and maintenance, such as outage management. In certain aspects, the project is outage management of a power plant, e.g., the management of a single turbine.

In another aspect, the invention provides a method of project management suitable for effective limited administrative management (ELAM) of a project. The method comprises the steps of: providing an interface for a primary user to interface with stored data; interfacing with the data through the interface provided; presenting to said primary user a project based advanced activity array using said interface; selecting a project to define one or more project assessments derived from the advanced activity array; assigning tasks from each assessment to one or more tertiary users; distributing said tasks to said tertiary users and requesting response input; monitoring the status of the response input from said tertiary users using active loop technology; and storing the response input for each task. In this way, a primary user may monitor the status of each task in each assessment of the project using the interface. In certain aspects, the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant. In certain aspects, the project is management of power plant operations and maintenance, such as outage management. In certain aspects, the project is outage management of a power plant, e.g., the management of a single turbine.

Another aspect of the invention provides a power plant management tool suitable for effective limited administrative management (ELAM) of power plant critical operations and maintenance, e.g., outage activities, comprising a machine-readable medium having instructions stored thereon for execution by a processor to perform a method. The method comprises the steps of: providing a dynamic graphical user interface (GUI) between stored power plant data, e.g., outage data, and a primary user, wherein said dynamic GUI may be modified by the primary user; presenting to said primary user an advanced activity array in said dynamic GUI based on power plant management, e.g., power plant outage management, wherein an array derivative data set is created upon selection of a turbine and comprises a framework for the data associated with one or more power plant management assessments derived from the advanced activity array; assigning tasks to one or more tertiary users; distributing said tasks to said tertiary users and requesting response input into the array derivative data set; monitoring the status of the response input into the array derivative data set from said tertiary users using active loop technology; and storing the response input for each task. In this way, a primary user may monitor the status of each task in each assessment of the power plant management in the dynamic GUI.

### BRIEF DESCRIPTION OF THE DRAWINGS

Advantages of the present apparatus will be apparent from the following detailed description, which description should be considered in combination with the accompanying drawings, which are not intended limit the scope of the invention in any way.

FIG. 1 depicts a flow diagram of certain project management tools of the present invention.

FIG. 2 depicts an exemplary dynamic GUI Dashboard for the project management tools of the present invention suitable for effective limited administrative management (ELAM) of a project; project selection is represented in this depiction.

FIG. 3 depicts an exemplary dynamic GUI Dashboard for the project management tools of the present invention suitable for effective limited administrative management (ELAM) of a project; presentation of an advanced activity array for an assessment is represented in this depiction.

FIG. 4 depicts an exemplary dynamic GUI Dashboard for the project management tools of the present invention suitable for effective limited administrative management (ELAM) of a project; the addition of lessons learned into the dynamic environment of the GUI by adding additional tasks into an assessment is represented in this depiction.

FIG. 5 depicts an exemplary dynamic GUI Dashboard for the project management tools of the present invention suitable for effective limited administrative management (ELAM) of a project; dynamic adjustment of the risk of a task is represented in this depiction.

### DETAILED DESCRIPTION OF THE INVENTION

The present invention is directed to project management tools, systems, and related methods, suitable for effective limited administrative management (ELAM) of one or more projects. The methods and tools presented herein are suitable for effective management by a single project administrator, or limited administrative team, without the need for significant expertise in the use of the tool. In particular, the present invention provides a project management tool for use in power plant operations and maintenance such as outage management.

The invention provides a novel user interface for project management by a single administrator that is capable of monitoring the status of every task in each assessment of a project. If tasks are assigned, monitored and in-turn assessments are confirmed adequately completed, on schedule, overall risks are minimized. As such, the methods, the tools, and the systems of the present invention provide stability, efficiency, improved quality through process management, risk identification, lessons learned and continuous improvement, which may be used for long-term standardization to assist a facility in managing projects, e.g., outages. Easy to interpret and multifaceted reporting tools can also ensure tracking, trending, and risk identifications are managed proactively.

The present invention, including project management tools, systems, and related methods will be described with reference to the following definitions that, for convenience, are set forth below. Unless otherwise specified, the below terms used herein are defined as follows:

### 1. DEFINITIONS

As used herein, the term “a,” “an,” “the” and similar terms used in the context of the present invention (especially in the context of the claims) are to be construed to cover both the singular and plural unless otherwise indicated herein or clearly contradicted by the context.

The term “assessment” is used herein to describe an industry recognized standard practice or a user configured practice associated with the determination of conditions, requirements, and need for tasks to be assigned ensuring the conditions and requirements are appropriately completed. Accordingly, these assessments are supported with associated and dynamic tasks. For example, if tasks are assigned, monitored and in-turn assessments are confirmed adequately completed, on schedule, overall risks are minimized.

The term “collecting” is used herein with respect to data and to describe the act of gathering data, e.g., for use in analysis and/or reporting.

The term “distributing” is used herein to describe the act of dispersing, e.g., tasks, by any electronic means. For example, in certain embodiments, distributing tasks is accomplished by notification through email, instant message, text message, or any combination thereof.

The term “dynamic” as used herein, for example in the expression “dynamic GUI,” describes the characteristic of evolving or changeable nature. For example, the dynamic GUI described herein may evolve through the incorporation of changes to the interface, e.g., through the advanced activity array (e.g., based on lessons learned).

The term “effective” as used herein, for example, in the language “effective management,” describes a characteristic of the tools, methods, and systems of the present invention useful for project management that show one or more of the following advantages: increases the likelihood of on-time and on budget project management, like power plant outage management and other critical operations and maintenance activities; supports a continuous improvement strategy; affords efficient use of time related to communications and task management; communication improvement, e.g., automated alerts; and/or ultimately results in significant cost savings related to projects, e.g., outages, as a result of early detection and risk mitigations.

The language “enterprise portal” is art-recognized as an internet based interface for users of enterprise applications, and provides access to enterprise information such as corporate databases, applications (including web applications), and systems.

The term “interface” as used herein, for example in the expression “graphical user interface,” or “GUI” is art-recognized, and describes a shared boundary across which two separate components of a computer system exchange information, which can be between software, computer hardware, peripheral devices, humans and combinations of these. For example, a graphical user interface, or GUI, facilitates the communication/interaction with stored data on a server by a user through the exchange of information or operation in the GUI. Moreover, the operation of two separate components across the boundary, as in a user operating in a graphical user interface to access stored information, is referred to herein as “interfacing.” In certain embodiments, the interfacing may be bi-directional. In other embodiments, the interfacing may be uni-directional. In particular embodiments, such interfacing may include, presenting, authentication, receiving, responding, and/or assigning a task to a tertiary user, e.g., after access and/or selection of the project in the dynamic GUI.

The language “machine-readable medium” is art-recognized, and describes a medium capable of storing data in a format readable by a mechanical device (rather than by a human). Examples of machine-readable media include magnetic media such as magnetic disks, cards, tapes, and drums, punched cards and paper tapes, optical disks, barcodes, magnetic ink characters, and solid state devices such as flash-based, SSD, etc. Machine-readable medium of the present invention are non-transitory, and therefore do not include signals per se, i.e., are directed only to hardware storage medium. Common machine-readable technologies include magnetic recording, processing waveforms, and barcodes. In particular embodiments, the machine-readable device is a solid state device. Optical character recognition (OCR) can be used to enable machines to read information available to humans. Any information retrievable by any form of energy can be machine-readable. Moreover, any data stored on a machine-readable medium may be transferred by streaming over a network. In a particular embodiment, the machine readable medium is a network server disk, e.g., an internet server disk, e.g., a disk array.

The language “power plant data” is art-recognized, and is used herein to describe data relevant for power plant operations and maintenance such as outage management. Such data includes, but is not limited to assessment actions, operations and maintenance risks, lessons learned, and file management of meta-data.

The language “primary user” is used herein to describe a person who is designated as the project administrator to serve as the coordinator for the project. In certain embodiments of the present invention, one to three primary users may be utilized and include the outage manager, the outage director, and a site administrator. In a particular embodiment, there is one primary user.

The term “risk” is used herein to describe the extent of the impact or potential impact of a negative result in an assessment or task, to the overall project, business, or facility (e.g., greater risk would be assigned to an assessment or task that is more critical to the overall success of a project), for example, if an assessment and/or assessment related task is not appropriately completed, when measured against an established schedule. Risks, and the criticality of such risks are dependent on the results of the standard assessments, user configured assessments, and tasks; wherein the results may be incorporated into the risk evaluation through the active loop technology.

The term “storing” is art-recognized, and is used herein to describe the act of saving data on a machine readable medium in a manner that such data is subsequently retrievable on that machine readable medium.

The term “task” as defined herein, describes an activity created, e.g., and assigned to an individual (i.e., a tertiary user), related to an aspect of the project management, e.g., power plant outage management and other critical operations and maintenance activities. The task, if completed in a thorough and timely manner will contribute to effective management of the project. For example, an effectively executed task may lead to one or more benefits including, but not limited to time savings, cost reductions, improved quality and improved communications, e.g., for plant personnel.

The term “multi-tenant” is art recognized, and is used to describe software architecture in which a single instance of software runs on a server and serves multiple tenants. A tenant (or customer) is a group of users who share a common access with specific privileges to the software instance.

The term “tertiary user” as used herein, describes a user of an interface with a role that has been assigned to them, for example, assigned a task or assessment for completion, e.g., with a corresponding request for response/data input.

The term “user” is used herein to describe any person that interfaces with the tools of the present invention. Such user may be a primary user or a tertiary user depending upon their role in the project management. Such user, in certain embodiments, interacts with the interfaces described herein through electronic means, e.g., computer or mobile device.

### II. METHODS OF THE INVENTION FOR PROJECT MANAGEMENT

The methods of the present invention offer a primary user the ability to monitor the status of each task in each assessment of a project in a dynamic GUI. The methods useful for project management described herein offer significant advantage over the available methods of project management. Such advantages include the effective management of a project by a single project administrator, or limited administrative team, without the need for significant expertise in the use of any tool used for management.

In certain embodiments of the present invention, the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant. In certain embodiments, the project is outage management and/or other critical operations and maintenance activities.

In certain embodiments of the present invention, the project is management of power plant operations and maintenance, such as outage management.

In certain embodiments of the present invention, the project is outage management of a power plant, e.g., the management of a single turbine.

A. General Embodiments of the Methods of the Invention

One embodiment of the present invention provides a method of project management suitable for effective limited administrative management (ELAM) of a project comprising the steps of:
providing a dynamic graphical user interface (GUI) between stored data and a primary user, wherein said dynamic GUI may be modified by the primary user (e.g., to incorporate lessons learned, e.g., by modifying the advanced activity array);
presenting to said primary user a project based advanced activity array in said dynamic GUI, wherein an array derivative data set is created upon selection of a project and comprises a framework for the data associated with one or more project assessments derived from the advanced activity array;
assigning tasks to one or more tertiary users, e.g., wherein the tasks are directly associated with an assessment, e.g., according to role/title;
distributing said tasks to said tertiary users and requesting response input into the array derivative data set;
monitoring the status of the response input into the array derivative data set from said tertiary users using active loop technology;
storing the response input for each task,

such that the primary user may monitor the status of each task in each assessment of the project in the dynamic GUI. In certain embodiments, the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant. In certain embodiments, the project is management of power plant operations and maintenance, such as outage management. In certain as embodiments, the project is outage management of a power plant, e.g., the management of a single turbine.

An additional embodiment of the present invention provides a method of project management suitable for effective limited administrative management (ELAM) of a project comprising the steps of
providing an interface, e.g., dynamic GUI, for a primary user to interface with stored data, e.g., wherein the tool may be modified by the primary user (e.g., to incorporate lessons learned, e.g., by modifying the advanced activity array);
interfacing with the data through the interface provided, e.g., through secure authentication;
presenting to said primary user a project based advanced activity array using said interface;
selecting a project to define one or more project assessments derived from the advanced activity array;
assigning tasks from each assessment to one or more tertiary users, e.g., according to role/title;
distributing said tasks to said tertiary users and requesting response input;
monitoring the status of the response input from said tertiary users using active loop technology (e.g., alerts may be sent following distribution as a reminder), e.g., frequency of reminders may be adjusted, e.g., based on risk;
storing the response input for each task,

such that the primary user may monitor the status of each task in each assessment of the project using the interface. In certain embodiments, the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant. In certain embodiments, the project is management of power plant operations and maintenance, such as outage management. In certain embodiments, the project is outage management of a power plant, e.g., the management of a single turbine.

In certain embodiments of the present invention, the method further comprises collecting and analyzing data. e.g., to incorporate into the dynamic GUI or advanced activity array, e.g., such as risk level modifications. In particular embodiments, the method further comprises using the data analyzed to prepare reports. In certain embodiments, the data is analyzed by using scoring, e.g., scoring algorithms, that assign weighted scores based on risk or importance for on-time or on-budget outages. In specific embodiments, the report may be used for identifying potential efficiency improvements or trends for one or more plants, e.g., a fleet.

In certain embodiments of the present invention wherein the project is power plant operations and maintenance such as outage management, the outage is a planned outage.

In certain embodiments of the present invention wherein the project is outage management, the outage is a planned outage.

In certain embodiments of the present invention wherein the project is power plant operations and maintenance such as outage management, the outage is an unplanned outage.

In certain embodiments of the present invention wherein the project is outage management, the outage is an unplanned outage.

In certain embodiments of the present invention, the method further comprises security authentication before user access to the dynamic GUI is granted. In certain embodiments, the security authentication is two-tiered (e.g., requiring a user ID and authentication code). In certain embodiments, the security authentication uses security encryption, e.g., at both ends of the interface. In certain embodiments, user access and rights are defined by security authentication, e.g., based on roles.

In certain embodiments of the present invention, the machine-readable medium is selected from the group consisting of magnetic media, optical disks, and solid state devices. In certain embodiments of the present invention, the machine-readable medium is a solid state device, e.g., an internet server disk, e.g., a disk array.

In certain embodiments of the present invention, the instructions stored on the machine-readable medium are online software. In particular embodiments, the software is an online application. In a specific embodiment, the software is a web-based application. In an alternative specific embodiment, the software is a cloud-based application.

In certain embodiments of the present invention, the interface, e.g., dynamic GUI, is accessed through the internet (e.g., an enterprise portal for web-based application) or gateway software. In a specific embodiment, the cloud computing platform and infrastructure is Microsoft Azure™.

In certain embodiments of the present invention, access to the interface, e.g., dynamic GUI, is accomplished by using the internet over a computer (e.g., desktop or laptop).

In certain embodiments of the present invention, access to the interface, e.g., dynamic GUI, is accomplished by using the internet over a mobile device (e.g., smartphone or tablet). In certain embodiments, access to the interface, e.g., dynamic GUI, is accomplished by launching an application on a smartphone.

i. Dynamic Graphical User Interface (GUI)

In certain embodiments of the invention, the methods of effective limited administrative management (ELAM) of a project comprise the step of providing a dynamic graphical user interface (GUI) between stored data and a primary user, wherein said dynamic GUI may be modified by the primary user (e.g., to incorporate lessons learned, e.g., by modifying the advanced activity array), such that the primary user may monitor the status of each task in each assessment of the project in the dynamic GUI.

The dynamic GUI is adaptable and configurable, e.g., to promote continuous improvement. Moreover, the dynamic GUI may be designed to allow for collaboration amongst different departments and entities while at different locations.

In certain embodiments, the dynamic GUI is configured prior to use of the tool by a primary user. Such configurations may incorporate user specific assessments (e.g., user configured/defined) into the advanced activity array.

In certain embodiments, the dynamic GUI may be modified by the primary user to incorporate lessons learned.

In certain embodiments, the dynamic GUI may be modified by the primary user by modifying the advanced activity array.

In certain embodiments, the primary user may modify the risk evaluation of an assessment and/or task based on the criticality of tasks and results of the assessment and/or task, e.g., which impact the outage assessment readiness and outage success (on time, on budget etc.).

In certain embodiments of the present invention, the dynamic GUI is accessed through the internet (e.g., an enterprise portal for web-based application) or gateway software. The tools of the present invention are independent of the cloud computing platform. In a specific embodiment, the cloud computing platform and infrastructure is Microsoft Azure™ (See, for example, Example 1).

In certain embodiments of the present invention, access to the dynamic GUI is accomplished by using the internet over a computer (e.g., desktop or laptop).

In certain embodiments of the present invention, access to the dynamic GUI is accomplished by using the internet over a mobile device (e.g., smartphone or tablet). In certain embodiments, access to the dynamic GUI is accomplished by launching an application on a smartphone, or other handheld devices.

ii. Advanced Activity Array

In certain embodiments, the primary user is presented a project based advanced activity array in the dynamic GUI. The advanced activity array is assembled/provided based on the selection of a project by the user (e.g., in the dynamic GUI), which comprises a listing of assessments and tasks related to the project. In particular embodiments, the advanced activity array is based on the collection and assembly of industry standards related to the project (including regulatory), as well as any user configured assessments.

The advanced activity array is selected based on the project. Moreover, an array derivative data set may be created upon selection of a project and comprises a framework for the data (e.g., for entry/input of the data) associated with one or more project assessments derived from the advanced activity array.

In certain embodiments, the methods of the present invention further comprise the step of selecting a project to define one or more project assessments derived from the advanced activity array.

In certain embodiments, one or more project assessments derived from the advanced activity array comprise assessing the facilities organizational intelligence, e.g., as it relates to a site's preparedness.

In certain embodiments, the advanced activity array is configurable or modifiable, e.g., by a user. In particular embodiments, the modification may be the addition, deletion, or amendment of an assessment or task. In a specific embodiment, the modification may be made through the dynamic GUI.

In certain embodiments, the listing of assessments and related tasks to a project are assembled by phase (e.g., 5 phases) and/or category. The phase selection is based on the length of time required for an action (e.g., those items that take longer start in an earlier phase; i.e., not all assessments are performed at the same time due to the different time investments needed for each) The category selection is based on the work type (e.g., things that need to be done). Tables 1 through 5 provide examples of assessments, e.g., for outage management of a power plant, including related tasks and risks, distinguished by phase (and then by category within each phase). However, as noted herein, such listing may be modified, substituted, or supplemented by user configured assessments, for example by lessons learned. Moreover, each listing is intended to be represented as both a group and an individual independent item.

TABLE 1
Examples of Phase 1 Assessments

| Assessment | Phase | Category |
|---|---|---|
| Initial Scope developed and communicated | 1 | Scope |
| to outage core team | | |
| Level-1 scope document uploaded and | 1 | Scope |
| released to core team | | |
| Pre-Outage meetings established and scheduled | 1 | Organization |
| Establish Outage team and reporting structure | 1 | Organization |
| Assign Outage Manager | 1 | Organization |
| Initial cost estimates prepared as per Budget | 1 | Cost |
| Level 1 cost estimate prepared and refined | 1 | Cost |
| with input from all leads | | |
| Special Tools, equipment needed for | 1 | Materials |
| outage identified | | |
| Long lead time parts identified | 1 | Materials |
| Procurement process established | 1 | Materials |
| HSE communication and training and | 1 | HSE |
| goals established | | |
| Initial HSE program and communication | 1 | HSE |
| plan established and communicated | | |
| HSE communication Plan is complete and | 1 | HSE |
| ready to release to contractors | | |
| Contracting Management Strategy established | 1 | Contracting |
| Firm Price contracting projects identified and | 1 | Contracting |
| communicated to contractors | | |
| Outside Contract services identified | 1 | Contracting |

*HSE is Health, Safety & Environmental

TABLE 2
Examples of Phase 2 Assessments

| Assessment | Phase | Category |
|---|---|---|
| scope refined with input from all leads | 2 | Scope |
| Level-2 Scope established and communicated | 2 | Scope |
| to all parties | | |
| Scope committee identifies required vs. | 2 | Scope |
| elective work items | | |
| Preliminary list of projects prepared for outage | 2 | Scope |
| Outage goals prepared and communicated | 2 | Scope |
| to all leads | | |
| Outage Manager identifies all leads | 2 | Organization |
| (IT, HSE, Legal, Insurance etc..) and assigns | | |
| specific tasks & responsibilities | | |
| Approved pre-outage milestone schedule | 2 | Schedule |
| released to all stakeholders | | |
| Outage manager distributes and uploaded Level-1 | 2 | Schedule |
| Milestone schedule | | |
| Draft outage execution task items prepared | 2 | Schedule |
| with duration and schedule | | |
| Scope control process established | 2 | Schedule |
| Summary schedule(Level 2) uploaded and | 2 | Schedule |
| released to plant management and all stakeholders | | |
| Level-2 Cost estimate established and published | 2 | Cost |
| Cost tracking process(reports etc..) established | 2 | Cost |
| Level 1 cost estimate uploaded and released | 2 | Cost |
| Long lead time parts finalized and uploaded | 2 | Materials |
| HSE program and communication plan | 2 | HSE |
| distributed to all parties including contractors | | |
| Emergent work approval process established | 2 | Contracting |
| contractor work schedule reviewed and uploaded | 2 | Contracting |
| Specific Outage goals established from input from | 2 | Performance |
| performance, HSE team and other leads | | |

TABLE 3
Examples of Phase 3 Assessments

| Assessment | Phase | Category |
|---|---|---|
| Scope reviewed and adjusted to reflect any changed | 3 | Scope |
| amended with work proposals from all leads | | |
| Level-3 Scope document prepared uploaded | 3 | Scope |
| and released | | |
| High Impact risk items identified and | 3 | Scope |
| captured in Risk register to manage | | |
| and mitigate before outage begins | | |
| Work Order task planning established | 3 | Scope |
| Initial Support interface identified and | 3 | Organization |
| communicated to all leads | | |
| Outage Manager assigns execution team | 3 | Organization |
| to implement the outage work as per scope | | |
| and schedule; all leads will have | | |
| specific tasks to execute | | |
| Level-3 Cost detail document established | 3 | Cost |
| and released | | |
| Contract negotiations and tendering complete | 3 | Contracting |
| Large Project work contracts awarded | 3 | Contracting |
| Outage Lessons learned reviewed if exists from | 3 | Support |
| previous outages and incorporated as appropriate | | |

*HSE is Health, Safety & Environmental

TABLE 4
Examples of Phase 4 Assessments

| Assessment | Phase | Category |
|---|---|---|
| Final List of projects prepared excluding | 4 | Scope |
| emergent works and released to all parties | | |
| Review and prioritize all work and | 4 | Scope |
| resource requirements, establish critical | | |
| path scope and validate to align with | | |
| business plan | | |
| User meetings and conference data reviewed for | 4 | Scope |
| final inclusion items/lessons learned | | |
| Service Bulletins, Technical Information, | 4 | Scope |
| OEM requirement documents, etc. | | |
| reviewed for final inclusion | | |
| Weekly or BI-Weekly outage meetings scheduled | 4 | Organization |
| and executed | | |
| Internal vacation request and coverage schedules | 4 | Organization |
| confirmed | | |
| Refined support requirements from all departments | 4 | Organization |
| Schedule refine meetings completed with focus on | 4 | Schedule |
| establishing more accurate schedule | | |
| Tooling Inspection | 4 | Schedule |
| Water wash or similar action considered and | 4 | Schedule |
| planned for including supplies | | |
| Generation protocol completed and | 4 | Schedule |
| notification finalized | | |
| Verify and document agreed market expectations | 4 | Schedule |
| Confirm strategy for shutdown timing and cool | 4 | Schedule |
| down periods | | |
| Level-3 schedule established, uploaded and | 4 | Schedule |
| released to all parties | | |
| Unit Shutdown and startup plan scheduled | 4 | Schedule |
| Customer “Hold Points” confirmed with critical | 4 | Schedule |
| contractors/vendors | | |
| Portable power stations considered, tested | 4 | Materials |
| and validated for staging | | |
| Chemical deliveries scheduled | 4 | Materials |
| Stage specialty tooling | 4 | Materials |
| Validate parts/components repaired | 4 | Materials |
| are onsite for outage | | |
| Drug testing strategy and notification complete | 4 | HSE |
| Emergency response teams notified | 4 | HSE |
| (Fire/Rescue/Other agencies) | | |
| Portable bathrooms staged | 4 | HSE |
| Smoking areas identified | 4 | HSE |
| Contractor parking prepared | 4 | HSE |
| Confined space signage | 4 | HSE |
| Waste disposal plan | 4 | HSE |
| Contractor qualification confirmed (Including | 4 | HSE |
| required safety training) | | |
| Waste oil and hazardous materials removed | 4 | HSE |
| from site | | |
| Housekeeping actions and checklist complete | 4 | HSE |
| Pre-Job Briefing area staged and supplies confirmed | 4 | HSE |
| Space close out inspection forms and assignments | 4 | HSE |
| validated and prepared | | |
| Spill kit availability and supply | 4 | HSE |
| Radio use policies and frequencies | 4 | HSE |
| communicated with vendors/contractors | | |
| Fork lift and portable equipment inspection | 4 | HSE |
| Inspect and restore specialty tooling | 4 | HSE |
| Crane certification/inspection | 4 | HSE |
| Scaffold process, inspections and staging area | 4 | HSE |
| Aerial lift inspection | 4 | HSE |
| Sling Inspection | 4 | HSE |
| SCBA inspection/certifications | 4 | HSE |
| Confirm Job Safety Assessments (JSA) are | 4 | HSE |
| available and complete for all outage tasks | | |
| Begin Clearance process if necessary for | 4 | HSE |
| materials and or staffing | | |
| Emergency Lighting checks | 4 | HSE |
| Extinguisher and fire system validation | 4 | HSE |
| Eyewash station confirmation/portables | 4 | HSE |
| Exit sign confirmation | 4 | HSE |
| Gas Detectors inspection/certification/quantity | 4 | HSE |
| LOTO lock boxes & locks/tags | 4 | HSE |
| Break schedules and turn-over times validated | 4 | Contracting |
| with primary contractors | | |
| Temporary lay-down areas identified and staged | 4 | Contracting |
| Contractor trailer/offices staged and prepared for | 4 | Contracting |
| water/sewer/comms | | |
| Validation of mitigation vendors/contractors | 4 | Contracting |
| contacts and numbers | | |
| Visitor log prepared and adequate for participants | 4 | Contracting |
| Pre-outage performance test completed | 4 | Performance |
| Validate parasitic loan plan for both shutdown | 4 | Performance |
| process and startup | | |

*HSE is Health, Safety & Environmental

TABLE 5
Examples of Phase 5 Assessments

| Assessment | Phase | Category |
|---|---|---|
| Units on gear/preparation check list completed | 5 | Scope |
| Post maintenance procedures and check off | 5 | Scope |
| sheets turned in | | |
| Startup plan and schedule confirmed | 5 | Schedule |
| and documented | | |
| Critical parts logs with operating data | 5 | Materials |
| (EOH/Started/etc.) | | |
| Confirmation of Insurance/Warranty needs and | 5 | Materials |
| appropriate parts quarantined | | |
| Complete and process Return/Repair material | 5 | Materials |
| authorization actions | | |
| Removed parts photo's validated, cataloged serial | 5 | Materials |
| numbers, crated and staged | | |
| Management of change completed and documented | 5 | HSE |
| Impacted drawings/literature cataloged and | 5 | HSE |
| processed for updates | | |
| Waste oil and hazardous materials removed | 5 | HSE |
| from site | | |
| Final space close out inspection collected | 5 | HSE |
| and validated | | |
| Close out review meeting with primary contractors | 5 | Contracting |
| completed | | |
| Draft reports received from critical contractors | 5 | Contracting |
| (Prior to leaving site) | | |
| Invoices received and validated with | 5 | Contracting |
| Purchase orders | | |
| Extra Work Authorizations are validated with | 5 | Contracting |
| daily reports and agreements | | |
| Contractor/Vendor scorecards collected | 5 | Contracting |
| and validated | | |
| Contractor trailer/office staging area cleaned | 5 | Support |
| and prepared for next outage | | |
| Reliability objectives validated | 5 | Performance |
| Unit walk downs complete with work order | 5 | Performance |
| requests completed | | |
| Insulation and thermographic inspections complete | 5 | Performance |
| Work orders/action plan defined based on | 5 | Performance |
| performance/reliability testing & validation | | |
| Post outage performance test completed | 5 | Performance |
| Initial operations round confirmed/DCS screen data | 5 | Performance |
| validation completed | | |

*HSE is Health, Safety & Environmental

iii. Assigning Tasks to Tertiary Users

Once a project is selected, tasks may be assigned to one or more tertiary users. In certain embodiments, the tasks are directly associated with an assessment. In certain embodiments, the tasks are assigned according to role or title.

iv. Distributing Tasks

Once assigned, the tasks may be distributed to tertiary users. Response input into the array derivative data set may be requested, e.g., in order to provide data related to a task or assessment of a project. Distribution to a tertiary user may include a path of distribution, for example, the response input from one tertiary user may be subsequently distributed to another tertiary user before returning to the primary user through active loop technology.

In certain embodiments, distributing the tasks is accomplished by notification through any suitable electronic means. In particular embodiments, distributing said tasks is accomplished by notification through email, instant message, text message, or any combination thereof.

v. Active Loop Technology (ALT)

The status of the response input from the tertiary users for each task, and the stored response input from the tertiary users may be monitored. Monitoring this input, and the corresponding status information, may be performed using active loop technology, which allows for ease of information cycle to and from active users through a linked alert array. In such alert array, automated alert notifications may be configured for tracking and offering status update notifications to relevant tertiary and primary users. In certain embodiments, alerts may be sent following distribution, e.g., as a reminder to the relevant user that input is required or has been entered. Moreover, frequency of reminders may be adjusted, e.g., based on risk. For example, if risks are ranked/scored above a predefined threshold, additional alerts would be sent to appropriate stakeholders, e.g., at definable intervals.

In certain embodiments, the active loop technology further comprises the step of displaying a project status indicator in the dynamic GUI, e.g., for easy/convenient viewing by a user. In particular embodiments, when all tasks associated with an assessment are complete, the assessment status transitions to a completed status automatically.

In certain embodiments, in addition to the automated alert notifications, the primary user may provide further manually triggered alert notifications.

B. Particular Embodiments of the Methods of the Invention

Another embodiment of the present invention provides a method of power plant management suitable for effective limited administrative management (ELAM) of power plant critical operations and maintenance, e.g., outage activities, comprising the steps of:
providing a dynamic graphical user interface (GUI) between stored power plant data, e.g., outage data, and a primary user, wherein said dynamic GUI may be modified by the primary user (e.g., to incorporate lessons learned, e.g., by modifying the advanced activity array);
presenting to said primary user an advanced activity array in said dynamic GUI based on power plant management, wherein an array derivative data set is created upon selection of a turbine and comprises a framework for the data associated with one or more power plant management assessments derived from the advanced activity array;
assigning tasks to one or more tertiary users, e.g., wherein the tasks are directly associated with an assessment, e.g., according to role/title;
distributing said tasks to said tertiary users and requesting response input into the array derivative data set;
monitoring the status of the response input into the array derivative data set from said tertiary users using active loop technology (e.g., alerts may be sent following distribution as a reminder), e.g., frequency of reminders may be adjusted, e.g., based on risk; and
storing the response input for each task, such that the primary user may monitor the status of each task in each assessment of the power plant management in the dynamic GUI.

An additional embodiment of the present invention provides a method of power plant management suitable for effective limited administrative management (ELAM) of power plant critical operations and maintenance, e.g., outage activities, comprising the steps of
providing an interface for a primary user to interface with stored power plant data, e.g., outage data, e.g., wherein the interface may be modified by the primary user (e.g., to incorporate lessons learned, e.g., by modifying the advanced activity array based on power plant management);
interfacing with the data through the interface provided, e.g., through secure authentication;
presenting to said primary user a power plant management based advanced activity array using said interface;
selecting a turbine to define one or more project assessments derived from the advanced activity array;
assigning tasks from each assessment to one or more tertiary users, e.g., according to role/title;
distributing said tasks to said tertiary users and requesting response input;
monitoring the status of the response input from said tertiary users using active loop technology (e.g., alerts may be sent following distribution as a reminder), e.g., frequency of reminders may be adjusted, e.g., based on risk;
storing the response input for each task, such that the primary user may monitor the status of each task in each assessment of the power plant management using the interface.

### III. TOOLS OF THE INVENTION FOR PROJECT MANAGEMENT

The methods of the present invention are useful as instructions stored on a machine-readable medium for execution by a processor to perform the method. In certain embodiments, the methods and tools of the present invention also make use and/or comprise a processor. Accordingly, any methods of the present invention, alone or in combination with other methods (such as those described herein or elsewhere) may be stored on a machine-readable medium for execution by a processor to perform the method. Such a composition comprises a tool of the invention useful for project management.

As such, in another embodiment, the invention provides a project management tool suitable for effective limited administrative management (ELAM) of a project comprising a machine-readable medium having instructions stored thereon for execution by a processor to perform a method comprising the steps of:
providing a dynamic graphical user interface (GUI) between stored data and a primary user, wherein said dynamic GUI may be modified by the primary user (e.g., to incorporate lessons learned, e.g., by modifying the advanced activity array);
presenting to said primary user a project based advanced activity array in said dynamic GUI, wherein an array derivative data set is created upon selection of a project and comprises a framework for the data associated with one or more project assessments derived from the advanced activity array;
assigning tasks to one or more tertiary users, e.g., wherein the tasks are directly associated with an assessment, e.g., according to role/title;
distributing said tasks to said tertiary users and requesting response input into the array derivative data set;
monitoring the status of the response input into the array derivative data set from said tertiary users using active loop technology; and
storing the response input for each task,

such that the primary user may monitor the status of each task in each assessment of the project in the dynamic GUI.

In certain embodiments, the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant. In certain embodiments, the project is outage management and/or other critical operations and maintenance activities.

In certain embodiments of the present invention, the project is management of power plant operations and maintenance, such as outage management.

In certain embodiments of the present invention, the project is outage management of a power plant, e.g., the management of a single turbine.

Another embodiment of the present invention provides a power plant management tool suitable for effective limited administrative management (ELAM) of power plant critical operations and maintenance comprising a machine-readable medium having instructions stored thereon for execution by a processor to perform a method comprising the steps of:
providing a dynamic graphical user interface (GUI) between stored power plant data, e.g., outage data, and a primary user, wherein said dynamic GUI may be modified by the primary user (e.g., to incorporate lessons learned, e.g., by modifying the advanced activity array);
presenting to said primary user an advanced activity array in said dynamic GUI based on power plant management, wherein an array derivative data set is created upon selection of a turbine and comprises a framework for the data associated with one or more power plant management assessments derived from the advanced activity array;
assigning tasks to one or more tertiary users, e.g., wherein the tasks are directly associated with an assessment, e.g., according to role/title;
distributing said tasks to said tertiary users and requesting response input into the array derivative data set;
monitoring the status of the response input into the array derivative data set from said tertiary users using active loop technology (e.g., alerts may be sent following distribution as a reminder), e.g., frequency of reminders may be adjusted, e.g., based on risk;
storing the response input for each task, such that the primary user may monitor the status of each task in each assessment of the power plant management in the dynamic GUI.

### IV. SYSTEMS OF THE INVENTION FOR PROJECT MANAGEMENT

The tools of the present invention may be used as part of a higher level system for use in project management by two or more tenants, wherein individualized access rights are provided to each tenant in order to separately (and, in certain embodiments, simultaneously) access the features and functions of the project management tools of the present invention. Such system is a multi-tenant system comprising one or more tools of the present invention, alone or in combination with tools described elsewhere in a multi-tenant environment.

### V. DESIGN ASPECTS OF THE INVENTION

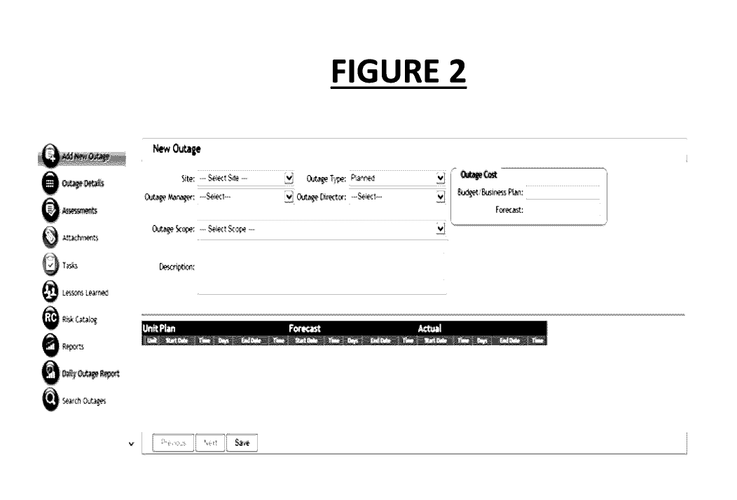

The ornamental appearance of any novel design provided herein is intended to be part of this invention, for example, the graphical user interface components of the specific examples; e.g., the present invention provides specific examples of a comprehensive GUI design of project management tools in FIGS. 2 through 5, which may form an independent or combined ornamental appearance of the project management tools and/or systems of the present invention described herein.

Accordingly, one embodiment of the present invention provides an ornamental design for a project management tool as shown and described.

### EXEMPLIFICATION

Having thus described the invention in general terms, reference will now be made to the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

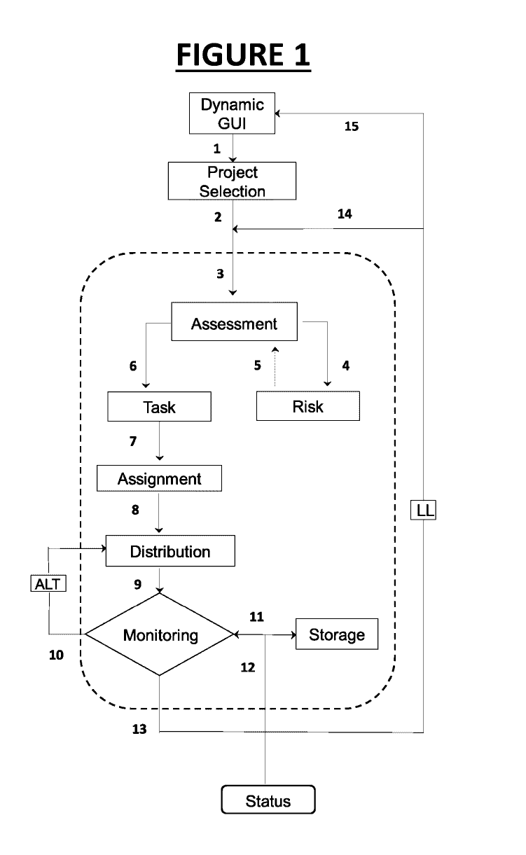

FIG. 1 depicts a flow diagram of certain project management tools of the present invention. In particular, the FIG. 1 depicts the path of data/input/interface of the primary user with the tool for use in monitoring the status of each task in each assessment of the project in the dynamic GUI, which affords the ability of the primary user to effectively manage a project through limited administrative management.

A project may be selected in 1 from the dynamic graphical user interface (GUI) provided to the primary user. The GUI is an interface between the stored data (and instructions) and the primary user. Moreover, the GUI may be modified by Lessons Learned (LL) 15. Once the project selection is made, the listing of assessments and tasks related to the project are presented 2 in an advanced activity array, which may be modified by Lessons Learned 14 and incorporated with the presentation 2 to form presentation 3 of an advanced activity array with user configured assessment(s). The risk of the assessments and the tasks related thereto are evaluated in 4; where additional risk or modification of existing risk may be made in 5 given the deadlines and due dates of assessment and/or task completions. Tasks are defined for each assessment in 6. The tasks are assigned in 7 and then distributed to tertiary users in 8, requesting response input into the array derivative data set, i.e., the framework for the data associated with one or more project assessments derived from the advanced activity array. Such distribution 8 may be the first distribution after assignment of tasks 7 to tertiary users, or may be the result of the active loop technology (ALT) 10. The ALT 10 allows for ease of information cycle to and from active users through a linked alert array that may be configured for tracking and offering status update notifications to relevant tertiary and primary users along with distribution reminders to the relevant user that input is required or has been entered. The ALT 10 may be achieved by monitoring 9 the status of the response input into the array derivative data set from the tertiary user. The input may be stored 11, and the storage may be monitored 11 in a manner to feed active status information back into the ALT 10, or result in completed status for the assessment. Upon assessment completion, Lessons Learned (LL) 13 may be used to offer guidance and improvement to the dynamic GUI 15 or the assessment listing 14.

Such instructions may be provided on a machine-readable medium having instructions stored thereon for execution by a processor, and comprise a project management tool of the present invention suitable for effective limited administrative management (ELAM) of a project. In this way, a primary user may monitor the status of each task in each assessment of a project in the dynamic GUI.

### Example 1

### Project Management Tools Using Microsoft SQL Azure Platform

A power plant outage management tool suitable for effective limited administrative management (ELAM) of power plant outage management was prepared using the Microsoft SQL Azure™ cloud platform. Such platform and infrastructure, created by Microsoft, allows for building, deploying and managing applications and services through a global network of Microsoft-managed datacenters. It provides both PaaS and IaaS services and supports many different programming languages, tools and frameworks, including both Microsoft-specific and third-party software and systems. Moreover, the Microsoft Azure™ Platform provides an API built on REST, HTTP, and XML that allows a developer to interact with the services provided by Microsoft Azure. Microsoft also provides a client-side managed class library which encapsulates the functions of interacting with the services. It also integrates with Microsoft Visual Studio, Git, and Eclipse.

### Example 2

### Dynamic Graphical User Interface (GUI)

### Dashboard

FIGS. 2 through 5 depict exemplary designs of a dynamic GUI Dashboard for the project management tools of the present invention suitable for effective limited administrative management (ELAM) of a project.

As shown in FIG. 2, selection of a new project, e.g., an outage, may comprise clicking or “pressing” a button presented on a dashboard.

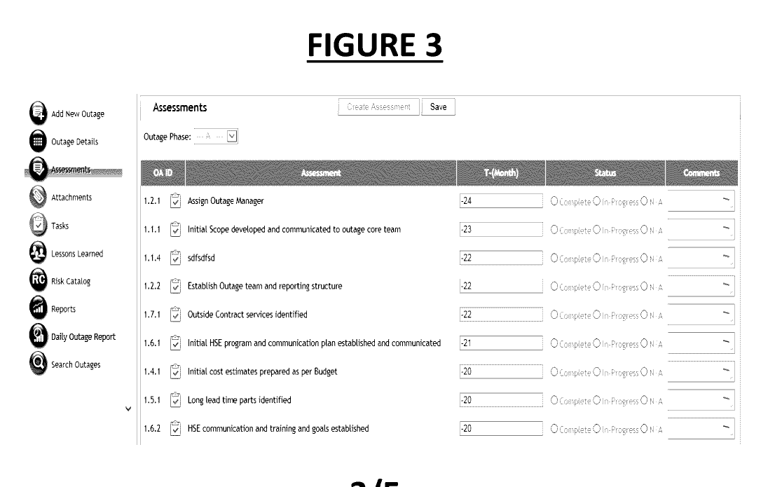

Once a project is selected, the assessments may be clearly presented in an advanced activity array, for example, in FIG. 3.

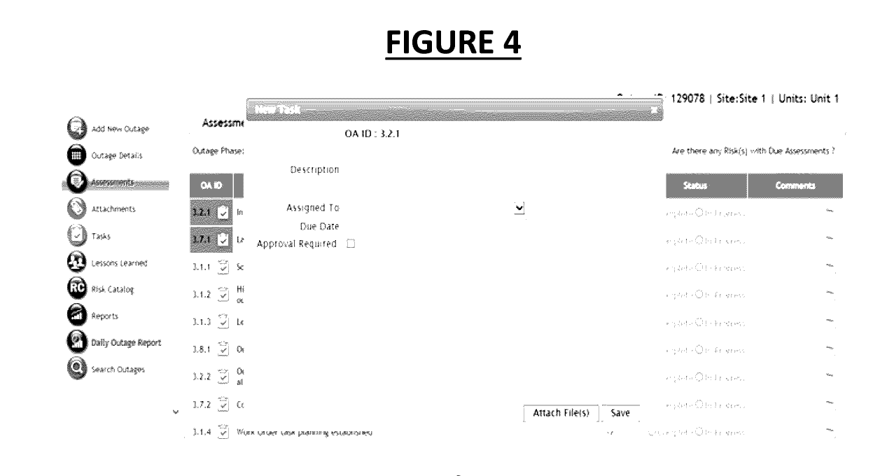

Each task may be selected, assigned, and distributed in, for example, a pop up menu. Moreover, adding lessons learned into the dynamic environment of the GUI by adding additional tasks into the assessment is shown in FIG. 4.

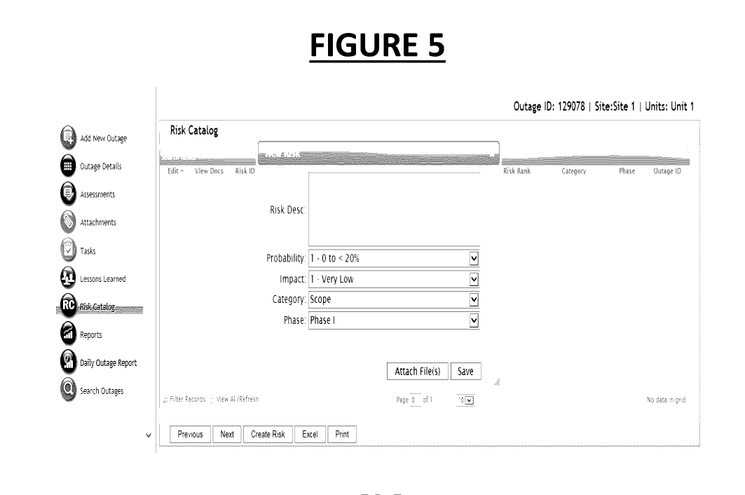

In addition, evaluating risk, for example, based on lessons learned may be used as a lesson learned to dynamically adjust the risk of a task; see FIG. 5.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A project management tool suitable for effective limited administrative management (ELAM) of a project comprising a machine-readable medium having instructions stored thereon for execution by a processor to perform a method comprising the steps of:
providing a dynamic graphical user interface (GUI) between stored data and a primary user, wherein said dynamic GUI may be modified by the primary user;
presenting to said primary user a project based advanced activity array in said dynamic GUI, wherein an array derivative data set is created upon selection of a project and comprises a framework for the data associated with one or more project assessments derived from the advanced activity array;
assigning tasks to one or more tertiary users;
distributing said tasks to said tertiary users and requesting response input into the array derivative data set;
monitoring the status of the response input into the array derivative data set from said tertiary users using active loop technology; and
storing the response input for each task,
such that the primary user may monitor the status of each task in each assessment of the project in the dynamic GUI.

2. The project management tool of claim 1, wherein the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant.

3. The project management tool of claim 2, wherein the project is management of power plant operations and maintenance.

4. The project management tool of claim 3, wherein the project is outage management of a power plant.

5. The project management tool of claim 2, wherein the power outage management is the management of an outage for a single turbine.

6. The project management tool of claim 1 further comprising collecting and analyzing data, and using the data analyzed to prepare reports.

7. The project management tool of claim 6, wherein the report may be used for identifying potential efficiency improvements or trends for one or more plants.

8. The project management tool of claim 1, wherein said dynamic GUI may be modified by the primary user to incorporate lessons learned.

9. The project management tool of claim 1, wherein said dynamic GUI may be modified by the primary user by modifying the advanced activity array.

10. The project management tool of claim 1, wherein the assignment of tasks is based on title or role.

11. The project management tool of claim 1, wherein distributing said tasks is accomplished by notification through any suitable electronic means.

12. The project management tool of claim 1, wherein the active loop technology creates reminder alerts that may be sent following distribution.

13. The project management tool of claim 1 further comprising the step of displaying a project status indicator in the dynamic GUI.

14. The project management tool of claim 1, wherein the machine-readable medium is selected from the group consisting of magnetic media, optical disks, and solid state devices.

15. A method of project management suitable for effective limited administrative management (ELAM) of a project comprising the steps of:
providing a dynamic graphical user interface (GUI) between stored data and a primary user, wherein said dynamic GUI may be modified by the primary user;
presenting to said primary user a project based advanced activity array in said dynamic GUI, wherein an array derivative data set is created upon selection of a project and comprises a framework for the data associated with one or more project assessments derived from the advanced activity array;
assigning tasks to one or more tertiary users;
distributing said tasks to said tertiary users and requesting response input into the array derivative data set;
monitoring the status of the response input into the array derivative data set from said tertiary users using active loop technology; and
storing the response input for each task,
such that the primary user may monitor the status of each task in each assessment of the project in the dynamic GUI.

16. The method of claim 15, wherein the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant.

17. The method of claim 16, wherein the project is management of power plant operations and maintenance.

18. The method of claim 17, wherein the project is outage management of a power plant.

19. The method of claim 16, wherein the power outage management is the management of an outage for a single turbine.

20. A method of project management suitable for effective limited administrative management (ELAM) of a project comprising the steps of
providing an interface for a primary user to interface with stored data;
interfacing with the data through the interface provided;
presenting to said primary user a project based advanced activity array using said interface;
selecting a project to define one or more project assessments derived from the advanced activity array;
assigning tasks from each assessment to one or more tertiary users;
distributing said tasks to said tertiary users and requesting response input;
monitoring the status of the response input from said tertiary users using active loop technology; and
storing the response input for each task,
such that the primary user may monitor the status of each task in each assessment of the project using the interface.

21. The method of claim 20, wherein the project is the selected from the group consisting of management of a power plant; chemical, chemical processing or chemical manufacturing plant; water or wastewater treatment plant; oil or other refineries; natural gas processing plant; biochemical plant; pharmaceutical plant; polymer manufacturing plant; and food processing plant.

22. The method of claim 21, wherein the project is management of power plant operations and maintenance.

23. The method of claim 22, wherein the project is outage management of a power plant.

24. The method of claim 21, wherein the power outage management is the management of an outage for a single turbine.
